(19) United States
(12) Patent Application Publication
(10) Pub. No.: US 2015/0057006 A1
(43) Pub. Date: Feb. 26, 2015

(54) Method and Apparatus for D2D Transmission

(71) Applicants: Chunyan Gao, Beijing (CN); Wei Bai, Beijing (CN); Haiming Wang, Beijing (CN)

(72) Inventors: Chunyan Gao, Beijing (CN); Wei Bai, Beijing (CN); Haiming Wang, Beijing (CN)

(21) Appl. No.: 14/356,484

(22) PCT Filed: Nov. 8, 2011
(86) PCT No.: PCT/CN2011/081933

§ 371 Date: May 16, 2014

(51) Int. Cl. H04W 72/04; H04W 76/02

(52) U.S. Cl. CPC H04W 72/04; H04W 76/023
USPC 455/450

(57) ABSTRACT

There is provided a method comprising: determining, at a first user terminal capable of performing a direct device-to-device, D2D, communication with a second terminal, whether to advance transmission in the D2D communication or not; obtaining information indicating whether the second user terminal is advancing its transmission in the D2D communication or not; and determining a structure for at least one communication interval in a D2D communication pattern at least partly based on the application of transmission timing advances at the first and second user terminals, wherein the D2D communication pattern comprises communication intervals allocated for communication for the first user terminal with respect to the second user terminal.

### FIELD

The invention relates generally to mobile communication networks. More particularly, the invention relates to a device-to-device (D2D) transmission.

### BACKGROUND

In radio communication networks, such as the Long Term Evolution (LTE) or the LTE-Advanced (LTE-A) of the 3^{rd} Generation Partnership Project (3GPP), network planning comprises the use of common base stations (Node B, NB). User equipment (UE), or a user terminal (UT), may communicate with another UT via the base station(s), for example. Alternatively, it is proposed that the UTs may communicate directly with each other by applying resources dedicated by the network for a device-to-device (D2D) direct communication. The D2D communication has proven to be network efficient by offloading the traffic processed in the base station(s), for example.

However, there are challenges related to optimization of the D2D transmission/reception efficiency. One of the problems is related to a relatively long distance between the D2D devices performing the D2D direct communication.

### BRIEF DESCRIPTION OF THE INVENTION

Embodiments of the invention seek to improve the communication efficiency in D2D communication.

According to an aspect of the invention, there is provided a method as specified in claim 1.

According to an aspect of the invention, there are provided apparatuses as specified in claims 15 and 29.

According to an aspect of the invention, there is a provided computer program product as specified in claim 30.

According to an aspect of the invention, there is provided an apparatus comprising means configured to perform any of the embodiments as described in the appended claims.

Embodiments of the invention are defined in the dependent claims.

### LIST OF DRAWINGS

In the following, the invention will be described in greater detail with reference to the embodiments and the accompanying drawings, in which

FIG. 1 presents a communication network, according to an embodiment;

FIG. 2 shows a signaling flow diagram according to an embodiment;

FIG. 3 shows a device-to-device (D2D) communication pattern according to an embodiment;

FIGS. 4 to 6 illustrates D2D communication scenarios according to some embodiments;

FIG. 7 presents a scenario where one user terminal is communicating with two user terminals over the D2D communication, according to an embodiment;

FIG. 8 depicts a scenario where a user terminal is utilizing a silent period, according to an embodiment;

FIG. 9 illustrates an apparatus according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller, a Node B, or an evolved Node B, for example), at least one user equipment (UE) (also called a user terminal, terminal device or a mobile station, for example) and optional network elements that provide the interconnection towards the core network. The base station may be node B (NB) as in the LTE, evolved node B (eNB) as in the LTE-A, a radio network controller (RNC) as in the UMTS, a base station controller (BSC) as in the GSM/GERAN, or any other apparatus capable of controlling radio communication and managing radio resources within a cell. The base station may connect the UEs via the so-called radio interface to the network. In general, a base station may be configured to provide communication services according to at least one of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols.

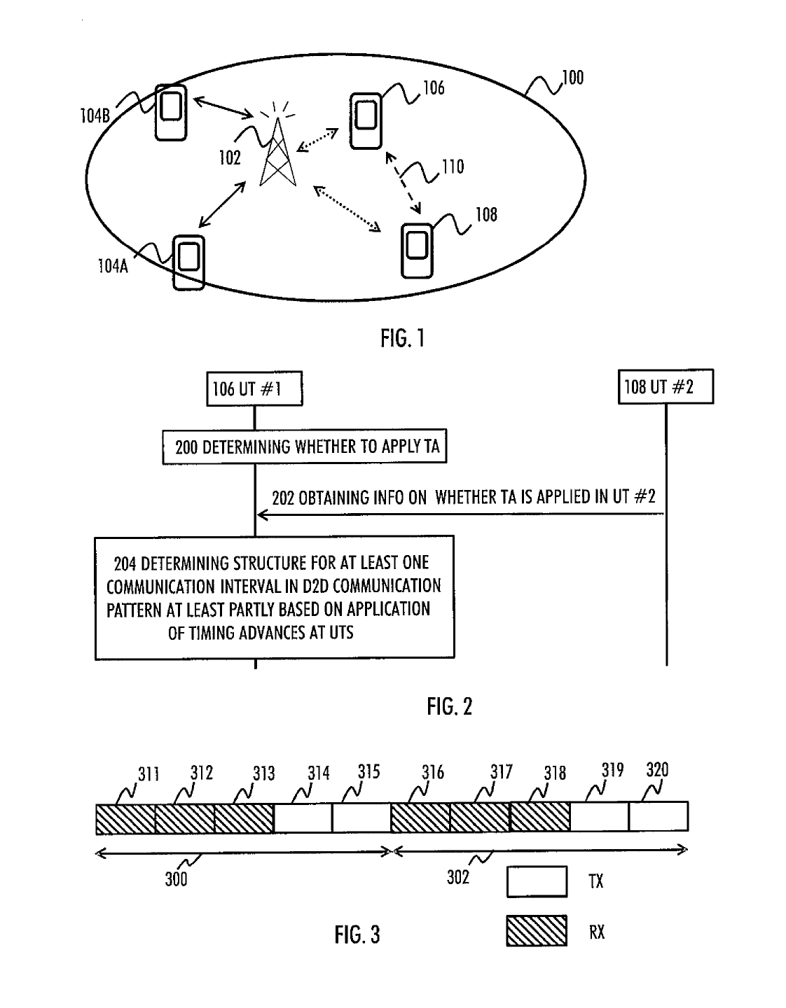

FIG. 1 shows a communication network where embodiments of the invention may be applicable. As explained, the communication network may comprise a base station 102. The base station 102 may provide radio coverage to a cell 100, control radio resource allocation, perform data and control signaling, etc. The cell 100 may be a macrocell, a microcell, or any other type of cell where radio coverage is present. Further, the cell 100 may be of any size or form, depending on the antenna system utilized. The base station 102 may be used in order to provide radio coverage to the cell 100. For the sake of simplicity of the description, let us assume that the base station is an eNB. The eNB 102 may control a cellular radio communication link established between the eNB 102 and terminal devices 104A and 104B located within the cell 100. These communication links marked with solid arrows may be referred as conventional communication links for end-to-end communication, where the source device transmits data to the destination device via the base station 100. Therefore, the user terminals 104A and 104B may communicate with each other via the base station 102. The terminal device may be a user equipment of a cellular communication system, e.g. a computer (PC), a laptop, a palm computer, a mobile phone, or any other user terminal or user equipment capable of communicating with the cellular communication network.

In addition to or instead of the conventional communication links, direct device-to-device (D2D) connections may be established among terminal devices. Direct communication links between two devices may be established, e.g., between terminal devices 106 and 108 in FIG. 1. The D2D communication may take place between cognitive radio-based devices 106 and 108, for example. A direct communication link 110 marked with a dashed arrow may be based on any radio technology such that the terminal devices 106 and 108 involved in the direct communication may apply communication according to any of a plurality of radio access technologies. The eNB 102 may be responsible for controlling the direct communication link 110, as shown with dotted, bi-directional line in FIG. 1. The radio access technology of the direct communication link 110 may operate on the same frequency band as the conventional communication link and/or outside those frequency bands to provide the arrangement with flexibility. Thus, the eNB 102 may be responsible for allocating radio resources to the direct communication link 108 as well as for the conventional communication links. Alternatively, the UT 106, 108 may perform auto-selection of D2D resources from a common pool of resources.

The D2D communication may improve the resource usage efficiency, reduce the power consumption both at the eNB 102 and at the UT 106, 108 side, off-load the traffic from the cellular network, reduce interference to other terminals and cells due to low transmit power, provide shorter end-to-end delay, etc. As said, the eNB 102 may control the D2D operation such that the resources are allocated by the eNB 102 and the D2D communication may take place by applying an uplink (UL) resource of the serving cellular system. This may allow the interference to be monitored by the eNB 102. However, specifications of the D2D communication for a large coverage in the D2D communication between two UTs 106 and 108 may differ from the specification of the D2D communication applying short distances. For a short range D2D operation, the propagation delay may be negligible and the synchronization between devices may be unnecessary once both UTs in the D2D communication pair may be synchronized to the serving cellular network. However, with an increased coverage, the propagation delay, for instance, may need to be considered. Furthermore, when one UT performs D2D communication with many other UTs, the distance between the paired devices may be different, which affects the propagation delay and other timing parameters, for example. Consequently, the synchronization to the network may not be as such enough for efficient and accurate D2D communication.

At least partly for this reason, it is proposed as shown in FIG. 2, that a first UT 106 capable of performing a D2D communication with a second UT 108 determines in step 200 whether to advance its transmission in the D2D communication or not. Such transmission advance might take place by applying a nonzero timing advance (TA), which may have a value corresponding to the length of time a signal takes to reach the second UT 108. This length of time may be called a propagation delay. Knowledge of the propagation delay may be obtained from the discovery process signaling which may have taken place prior to the actual D2D data communication. In the discovery process, UTs 106 and 108 may (both or one of them) broadcast discovery signals so that other UTs capable of D2D direct communication may obtain knowledge that D2D devices are present and in reach. It should be noted here that TA may also have a value of zero (TA=0). Throughout the application such TA=0 corresponds to TA not being applied. Thus, only when TA has a non-zero value, the TA is being applied and transmission is being advanced.

In an embodiment, the determination whether to apply the TA in the D2D transmission, i.e. whether to advance own transmission, may be based on the number of simultaneous target D2D receivers. Because the TA values may also on the distance between the transmitter and the receiver, the TA value may be different for different receivers. Therefore, in case the transmitter needs to send data to multiple receivers at the same time, it may be difficult to select a proper TA which is suitable for all target receivers. In such case, the UT 106 may decide not to use the TA (i.e. TA=0). However, in case of only one target receiver, the TA may be of use. Alternatively or in addition to, the TA value may depend on the propagation delay, i.e. the distance between the D2D devices. For example, when the distance is less than a certain threshold, e.g. 70 meters, away, the propagation delay may be assumed to be less than one TA step specified in the current cellular network. In such a case, the TA may be set to zero (no TA).

In step 202 the UT 106 may obtaining information indicating whether the second user terminal is advancing its transmission in the D2D communication or not. Thus, the UT 106 obtains information of the application of TA at the second UT 108. If the transmission is advanced, then the TA is being applied. In this case, the UT 108 may also obtain knowledge of the value of TA, i.e., how much the transmission from the UT 108 is being advanced. If the transmission is not advanced, then the TA is not applied. The UT 106 may obtain such information directly from the second UT 108. Alternatively, the eNB 102 of FIG. 1 may indicate such information to the UT 106 when the eNB 102 possesses such information. The eNB 102 may be aware of the target D2D receivers of any D2D device, such as the UT 106, and the eNB 102 may know whether TA is used at the target D2D devices. The eNB 102 may have obtained the information through control/configuration signaling via the dotted lines in FIG. 1, for example. Consequently the eNB 102 may then inform the UT 106 in configuration signaling, for example.

Therefore, each of the D2D devices (UT 106 and UT 108) in the D2D pair may independently determine whether to use the time advance, or timing advance, in its transmission and exchange information with the paired D2D device on the application of the TA. Thereafter, in step 204, the UT 106 may determine a structure for at least one communication interval in a D2D communication pattern at least partly based on the application of transmission timing advances at the user terminals, wherein the D2D communication pattern comprises communication intervals allocated for communication for the first user terminal with respect to the second user terminal. The communication intervals allocated for communication may include intervals allocated for at least one of the following: transmission and reception. The structure for the at least one communication interval in the D2D communication pattern is thereafter applied by the UT 106 in communication of information to/from the UT 108. The communication interval structure and the D2D communication pattern may be a D2D pair-specific.

Let us take a closer look at the D2D communication pattern for one UT, such as for UT 106, as shown in FIG. 3. FIG. 3 shows two consecutive D2D communication patterns 300 and 302. Even though not shown in FIG. 3, the D2D patterns 300 and 302 may be selected to be different in order to provide flexibility in the D2D communication. Each of the patterns 300 and 302 comprises communication intervals 311 to 320 allocated for communication, i.e. for transmission and/or reception. The intervals 311 to 313 and 316 and 318 marked with left leaning diagonal lines may be allocated for reception (Rx) of data from at least one other D2D UT, such as from the UT 108. The communication intervals 314, 315 and 319, 320 are allocated for transmission (Tx) from the UT106 to the other D2D device(s). The communication intervals 311 to 320 may be seen as time resources available for the use of UT 106 in D2D communication. The D2D communication pattern configuration (i.e. the allocation of Rx and Tx intervals) may be designed based on current traffic situation at the UT 106 and at the paired device 108. The configuration may be adopted later to accommodate appropriate amount of resources for the D2D communication pair. The eNB 102 may have informed the UTs 106 and 108 about the D2D communication pattern via the control/configuration signaling. Although different patterns are possible, having identical patterns 300 and 302 may be advantageous so that the control signaling may be minimized. In an embodiment, each communication interval 311 to 320 is a subframe. For example, in the LTE, the frame is divided into 10 subframes, each with 1 ms duration. It should also be noted that the Tx and Rx allocation may be consecutive or non-consecutive. For example, there may be at least one unused subframe in the D2D pattern 300 or 302.

As said, the UT 106 may determine a structure for the at least one communication interval 311 to 320 in a D2D communication pattern 300 and 302. The structure of any communication interval 311 to 320 may be such that the whole interval is reserved for the Tx or the Rx, as shown in FIG. 3. However, the structure may also be advantageously changed such that only part of the interval is reserved for the Tx or the Rx. Such structure may be needed to ensure that all transmitted data packets may be received before the receiving device turns into transmission, or to ensure that the receiving device does not turn into transmission before all data is received. Thus, the proposed embodiments may provide an optimized communication interval structure at the switching point of Rx and Tx to handle the propagation delay and Tx/Rx switching. The UT may decide to reconfigure the format for several subframes within the D2D communication pattern 300 or 302. The proposed solution may be applicable to D2D communication sharing resources with a cellular communication network. Further, the proposed solution may be advantageously applicable to situations where the distance between the communicating D2D devices may be large, such as larger than in a wireless local area network (WLAN) or in the WiFi. The determination of the structure of the communication interval(s) may take into account the possibility of using different TAs for different D2D pairs due to different propagation delays. In addition the D2D device may perform the reconfiguring of the subframes, i.e., the communication intervals 311 to 320, autonomously which reduces signalling overhead.

It should be noted with respect to FIG. 2, that when the UT 108 determines the structure for the at least one communication interval in a D2D communication pattern applied by the UT 108, the UT 106 may cause transmission of information to the second user terminal 108, wherein the information indicates whether the first user terminal 106 is advancing its transmission in the D2D communication. Alternatively, the UT 108 may obtain such information from the network.

In an embodiment, the UT 106, as a D2D device, may determine the presence and possibly the length of at least one of the following: a guard period and a silent period in the at least one communication interval when determining the structure. The silent period is applicable once after transmission and before reception of information in the D2D communication, and the guard period is applicable once after reception and before transmission of information in the D2D communication. More particularly, the guard period (GP) is defined as a blank period which is used after the Rx occasion and before the Tx occasion. The GP is used to ensure there is no overlap of Tx and Rx at the UT 106 itself. A silent period (SP) is defined as a blank period which is used after the Tx occasion and before the Rx occasion. The SP is used to ensure there is no overlap of Tx and RX at the peer side, i.e. at the UT 108, so the UT 106 itself may have some other action during this period. For a D2D pair, one device's GP is another's SP, and vice versa. Let us now look at how it is determined whether or not to apply the GP and/or the SP.

In an embodiment, a first UT of the D2D communication pair, such as the UT 106, may determine to apply a SP in the at least one communication interval when the first UT 106 does not apply the transmission timing advance, i.e. does not advance its transmission. As noted, not applying TA may denote TA=0 or no TA defined. In an embodiment, the SP is comprised in the last communication interval allocated for transmission in the D2D communication pattern with respect to the current D2D communication pair. In other words, the SP may be comprised in the last transmission subframe. That is, a D2D device which transmits without TA (e.g. TA=0), the D2D device may assume a SP in its last Tx subframe in one D2D communication pattern.

In an embodiment, the first UT 106 may determine not to apply the SP in the at least one communication interval when the first UT 106 applies the transmission timing advance. That is, the D2D device may not assume any SP in its Tx subframes when the D2D device transmits with a TA.

In an embodiment, the first UT 106 may determine to apply a GP in the at least one communication interval when the second UT 108 does not apply the transmission timing advance. Again, not applying TA may denote TA=0 or no TA defined. The guard period may be comprised in the last communication interval allocated for reception in the D2D communication pattern with respect to the current D2D communication pair. In other words, the GP may be comprised in the last reception subframe. That is, a D2D device may assume a GP in its last Rx subframe in the D2D communication pattern with respect to the paired D2D device when its D2D communication pair transmits without TA.

In an embodiment, the first UT 106 may determine not to apply the GP in the at least one communication interval when the second UT 108 applies the transmission timing advance. That is, a D2D device may not assume any GP in its Rx subframes in the D2D communication pattern with respect to the paired D2D device when its D2D communication pair transmits with a TA. In this manner each of the devices in the D2D pair, e.g. the UTs 106 and 108, determines the GP/SP configuration, e.g. the presence of GP/SP in at least one Tx or Rx subframe.

In addition, the length of the GP and/or SP may be defined. In an embodiment, when the D2D communication pattern comprises only the SP or the GP, the length of the SP or the GP corresponds to at least two times the sum of a propagation delay between the first and the second user terminals 106 and 108 and a duration of switching from transmission to reception or vice versa. Put in an equation, in case there is only one GP or SP in the Rx or Tx subframe, respectively, the length L of the GP or SP may be defined as L>=2*(ΔTₚᵣₒₚ+ΔT_{switch}), wherein ΔTₚᵣₒₚ is the propagation delay between the D2D devices in the communication pair, and ΔT_{switch} is the time duration for switching from Tx to Rx or vice versa. The ΔTₚᵣₒₚ may be known from the discovery process signal detection, which may have preceded the actual D2D data communication. The value of ΔT_{switch} may be a broadcasted value by the eNB 102, which is known to all D2D devices. This ΔT_{switch} value may be a common value for all UTs and configured by the eNB 102. For example, it may be a value deduced from history information.

In another embodiment, when the D2D communication pattern comprises both the SP and the GP, the length of each of the SP and the GP corresponds to at least the sum of a propagation delay between the first and the second user terminals 106 and 108 and a duration of switching from transmission to reception or vice versa. Again, put in the equation format, in case there are both a SP in the Tx subframe and a GP in the Rx subframe, the GP and SP may have the same length and the length L may be defined as L>=ΔTₚᵣₒₚ+ΔT_{switch}.

Although the SP ad GP length may be larger than 2*(ΔTₚᵣₒₚ+ΔT_{switch}) or (ΔTₚᵣₒₚ+ΔT_{switch}), they do not need to be. In an embodiment, the lengths L equal to either 2*(ΔTₚᵣₒₚ+ΔT_{switch}) or to (ΔTₚᵣₒₚ+ΔT_{switch}), depending on the application of non-zero TA in the D2D communication pair. This embodiment may provide efficient time resource usage in the D2D communication.

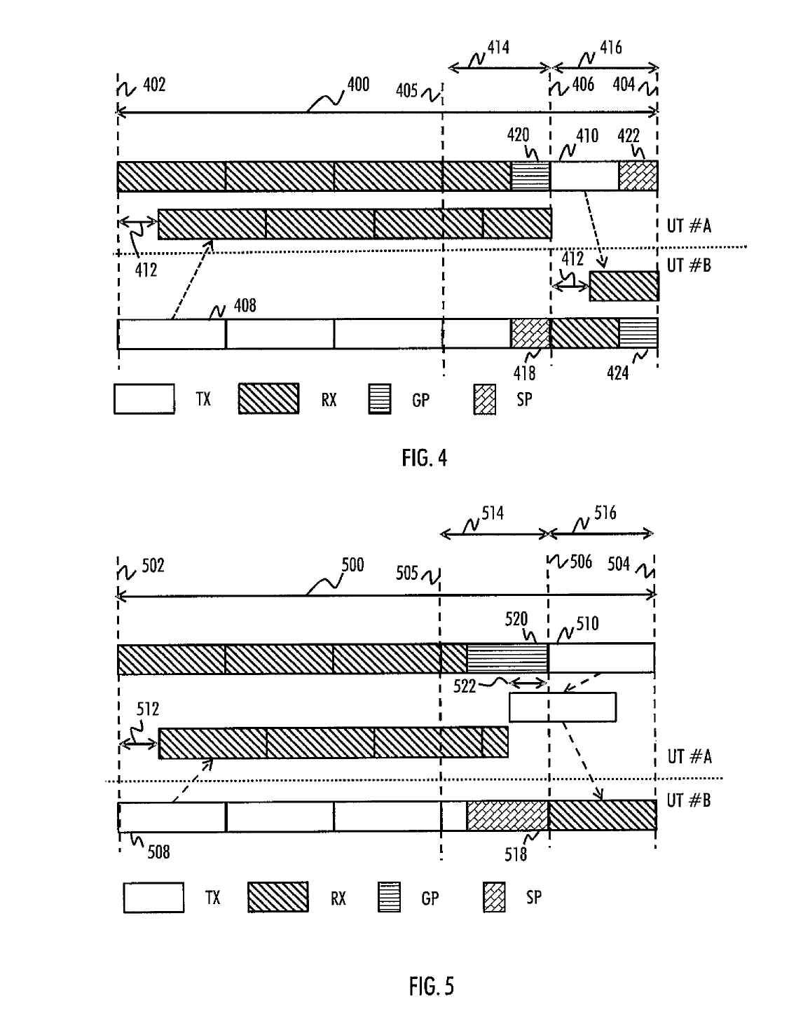

Let us now look at examples to more clearly show the SP/GP configuration and communication structure determination in a D2D communication pair. FIGS. 4 to 6 depict different D2D communication scenarios and how the structures of one or more communication intervals are defined in the scenarios. FIG. 4 illustrates a D2D communication between two devices A and B, such as between UT#A and UT#B. It is assumed in FIG. 4 that both the device A and the device B may transmit at the same timing as cellular downlink (DL) time. This may denote that the devices A and B obtain the DL transmission timing of the cellular network prior to the D2D data direct communication. Thereafter, during the D2D data communication, the devices A and B may use this timing. In the example of FIG. 4, the device A has a D2D communication pattern 400 of 4Rx+1Tx, while the device B has the opposite D2D pattern of 4Tx+1Rx. Dashed vertical lines 402 and 404 show the start and end of the D2D communication pattern 400, respectively. There may be more than one D2D communication pattern applied in the data communication between the devices A and B but for simplicity reasons, only one 400 is shown. The other possible D2D patterns may apply the same Rx/Tx configuration or a different one. A dashed vertical line 405 depicts the start of the last interval for reception by the device A and the start of the last interval for transmission for the device B. A dashed vertical line 406 depicts the transition from Tx to Rx or vice versa. A dotted horizontal line divides the figure for functionalities at the device A and device B. It is assumed in FIG. 4 that both devices A and B transmit without TA (or TA=0).

As shown in FIG. 4, the data 408 transmitted from the device B may arrive the device A with a delay 412. For this reason, the last Tx subframe 414 of device B may comprise a silent period (SP) 418 so as to make sure the transmitted data 408 arrives at the device A in time before the start of the next subframe 416 and also to allow the device A to switch from Rx to Tx so that the device A may transmit at the start of the next subframe 416. Correspondingly, a guard period 420 is comprised in the last Rx subframe 414 of device A. Similarly, data 410 transmitted from the device A to the device B may arrive device B with the delay 412. In order to guarantee that the device B can start transmission from the beginning of the next subframe and to make sure that the data 410 is received by the device B in time before the start of next subframe (or communication interval) may take place in the next D2D communication pattern, the last transmission subframe 416 of device A may comprise a silent period 422. Correspondingly, the device B may have a guard period 424 in the last reception communication interval 416. As there are both GP and SP present in the D2D communication pattern 400 of one device, the length of GP and SP is ΔTₚᵣₒₚ+ΔT_{switch}, as previously explained, wherein ΔTₚᵣₒₚ corresponds to the propagation delay 412. As can be seen from the Figure, the GP and SP configuration allow the transmitted data to be received so that the receiving device may receive the data in time before the next communication interval. The receiving device may still have time to switch to Tx before the start of the next communication interval so that the transmission may start at the beginning of the next interval. In practice, the data part of the last Tx and/or Rx subframe may be reduced so that the SP or the GP having the required length L may be fitted in the subframe.

FIG. 5 illustrates a D2D communication between two devices A and B, such as UT#A and UT#B. It is assumed in FIG. 5 that the device A transmits with a timing advance to guarantee that the data arrives at the device B at the time corresponding to the cellular DL synchronization. However, the device B transmits with the same timing as the cellular DL time, i.e. its transmission is synchronized with the cellular downlink. As in FIG. 4, in the example of FIG. 5, it is assumed that the device A has a D2D communication pattern 500 of 4Rx+1Tx, while the device B has the opposite D2D pattern of 4Tx+1Rx. Dashed vertical lines 502 and 504 show the start and end of the D2D communication pattern 500, respectively. A dashed vertical line 505 depicts the start of the last interval for reception by the device A and the start of the last interval for transmission for the device B. A dashed vertical line 506 depicts the transition from Tx to Rx or vice versa. A dotted horizontal line divides the figure for functionalities at the device A and device B.

In the example of FIG. 5, the device B transmits data 508 without TA so the device B starts its transmission at point 502 (beginning of its first transmission interval (or subframe). However, the data is received at the device A with a delay of 512. As the device B does not apply any TA (or TA=0), the device B may add a silent period 518 in the last transmission subframe 514. Correspondingly, the last reception interval 514 of the device comprises a guard period 520 corresponding to the silent period 518. As seen from FIG. 5, when the device A has its turn to transmit data 510, the device A may apply a nonzero timing advance 522 which causes the device A to actually transmit the data in advance compared to the start of the allocated transmission interval 516 of device A. The amount of timing advance 522 may depend on the propagation delay between the devices A and B. As the device A applies a non-zero TA, no SP is be needed to the device A's transmission interval 516. Correspondingly, the last reception subframe 516 of device B may also be without any guard period. The timing advance 522 may ensure that the data arrives to the device B at the start 506 of the reception subframe 516 of device B. Thus, all data 510 may be received before the end of the subframe 516. The SP 518 may guarantee the time required for the device A to switch from Rx to Tx and to obtain the data 508 before the start of the device A's Tx period 516. As there is only the SP in the D2D pattern of device B and only the GP in the D2D communication pattern of device A, the length of the GP and the length of the SP is determined to be at least 2*(ΔTₚᵣₒₚ+ΔT_{switch}), wherein ΔTₚᵣₒₚ corresponds to the propagation delay 512.

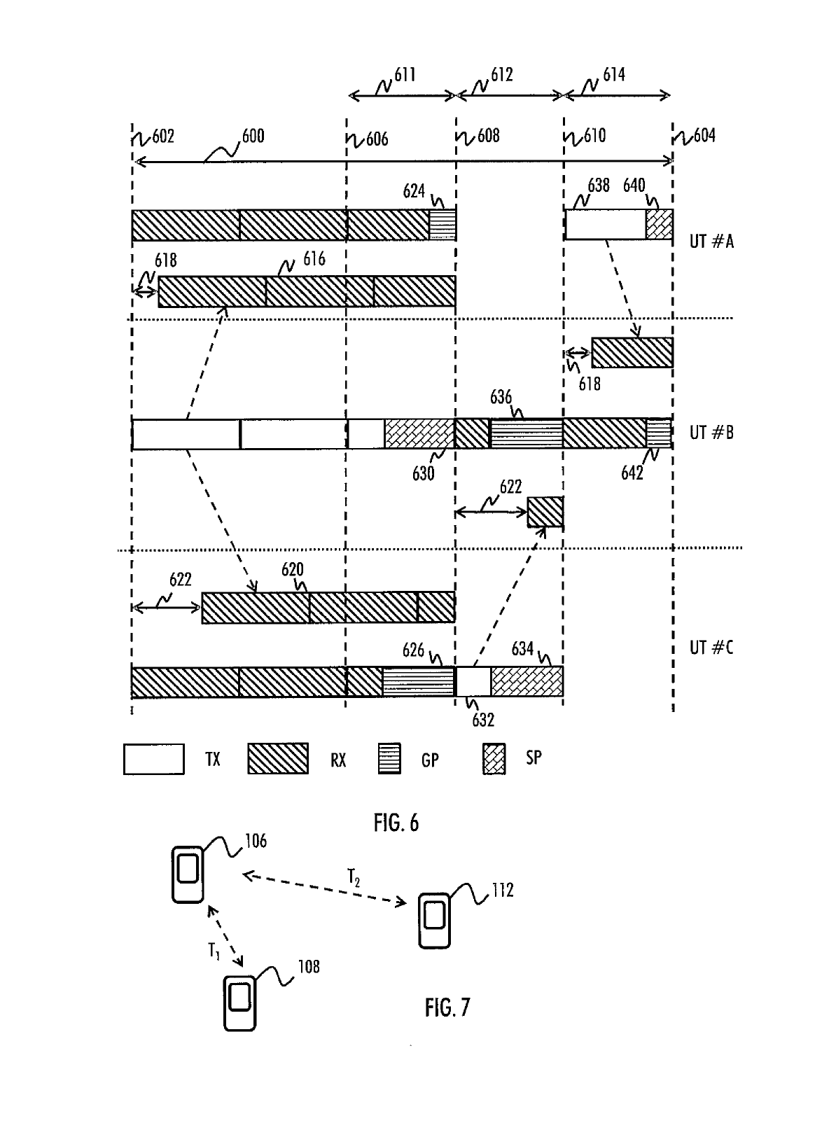

FIG. 6 depicts a scenario where a device B communicates directly with devices A and C. It is assumed in FIG. 6 that each device A to C transmits at the same timing as the cellular downlink (DL) time, i.e. they are synchronized to the DL timing. In the example of FIG. 6, the device A has a D2D communication pattern 600 of 3Rx+1Tx with one unallocated interval in between, the device B has a D2D pattern of 3Tx+2Rx, and the device C has a D2D communication pattern of 3Rx+1Tx with one unallocated interval at the end. Dashed vertical lines 602 and 604 show the start and end of the D2D communication pattern 600, respectively. Again, there may be more than one D2D communication pattern applied in the data communication between the devices but for simplicity reasons, only one pattern 600 is shown. The other possible D2D patterns may apply the same Rx/Tx configuration or a different one. A dashed vertical line 606 depicts the start of the last reception interval for devices A and C and the start of the last transmission interval for the device B. A dashed vertical line 608 depicts the change from Tx to Rx for the device B and the switch from Rx to Tx for the device C. A dashed vertical line 610 depicts start of transmission interval for the device A and the end of transmission interval for the device C. A dotted horizontal line divides the figure for functionalities at the devices A to C. It is assumed in FIG. 6, that each device A to C transmits without TA (or TA=0).

As can be seen, the FIG. 6 relates to scenario with several D2D pairs. This is also depicted in FIG. 7 where it is shown that the UT 106 performs D2D communication with two user terminals, the UT 108 and a user terminal 112. However, as said, the propagation delays T₁ and T₂ may be different. Therefore, the same TA may not be suitable. Also, the configuration of SP/GP may need to be determined separately for each D2D communication pair.

In FIG. 6, the device B transmits data substantially simultaneously to both devices A and C. However, the propagation delay may be different to the device A than to the device C. As shown, the device A receives transmitted data 616 after a delay 618, whereas the device C receives transmitted data 620 after a delay 622, wherein delays 618 and 622 are of different lengths. This may be because the distance between the device A and the device B, and the distance between the device C and the device B may be different. In the example of FIG. 6, the delay 622 is longer than the delay 618. This may affect the selection of lengths for the guard periods 624 and 626 which may be introduced in the last reception intervals 611 of the devices A and C. Correspondingly, the silent period 630 for the communication pair B-C in the last TX subframe 611 of the device B may be of different length than the silent period for the communication pair B-A (although this latter guard period for pair B-A is not shown in FIG. 6 for simplicity reasons). As a result, in an embodiment, the user terminal B may transmit more data 616 to the device A, which has a shorter duration of SP and/or GP in the communication pattern corresponding to D2D communication pair B-A., than to the UT C, which has a longer duration of SP and/or GP in the communication pattern corresponding to D2D communication pair B-C.

During subframe 612 the D2D communication patters, which may be indicated to the devices A to C by the eNB, for example, the device C has a transmission allocation. Transmitted data 632 may be delayed by the propagation delay 622. However, a silent period 634 and a guard period 636 may ensure that all the data is received at the device B before the start of the next communication interval 614.

During the communication interval, or subframe, 614, the device A has a transmission time slot. Data 638 transmitted from the device A may be received by the device B after the delay 618 which corresponds to the propagation delay between the devices A and B. However, a SP 640 and a GP 642 in the subframe 614 may ensure that the reception is completed and the devices A and B have enough time to switch from Tx to Rx or vice versa before the point 604 of time. Therefore, the device B applies different GPs 636 and 642 to D2D communications between the devices B and C, and A and B, respectively. Also different SPs are applied. For example, the length of the SPs and GPs may vary depending on the communication pair, as shown in FIG. 6. In other words, the device A may determine the GP/SP based on the delay 618 while the device C may determine the GP/SP based on the delay 622. As for device B, it may determine the GP/SP based on the delay 618 for subframes used for communication with the device A, and it may further determine the GP/SP based on the delay 622 for subframes used for communication with the device C.

Thus, in an embodiment, a first user terminal, such as the device B in FIG. 6, may determine the structure for at least one communication interval in a plurality D2D communication patterns corresponding to a plurality of D2D communication pairs when there is a plurality of second user terminals, such as the devices A and C, wherein the determination is based at least partly on the application of the transmission timing advances in each of the plurality of D2D communication pairs. It should also be noted that because one device may communicate with one or multiple devices, then in some communication pairs there may be a non-zero TA applied in transmission, while in other communication pairs there is no TA (or the TA=0). The devices may thus configure each communication pair separately. In an embodiment, when the information exchange related to the TA application is available, the GP/SP configuration may be performed in each device without introducing any new signaling. This may provide an efficient D2D resource utilization and reduce the required time for coordination. As shown in the examples, the proposed solution may enable the device to determine the GP configuration implicitly based on the TA configuration in itself and the paired device. The proposed solution may thus maximize the effective transmission/reception time, which may improve the performance.

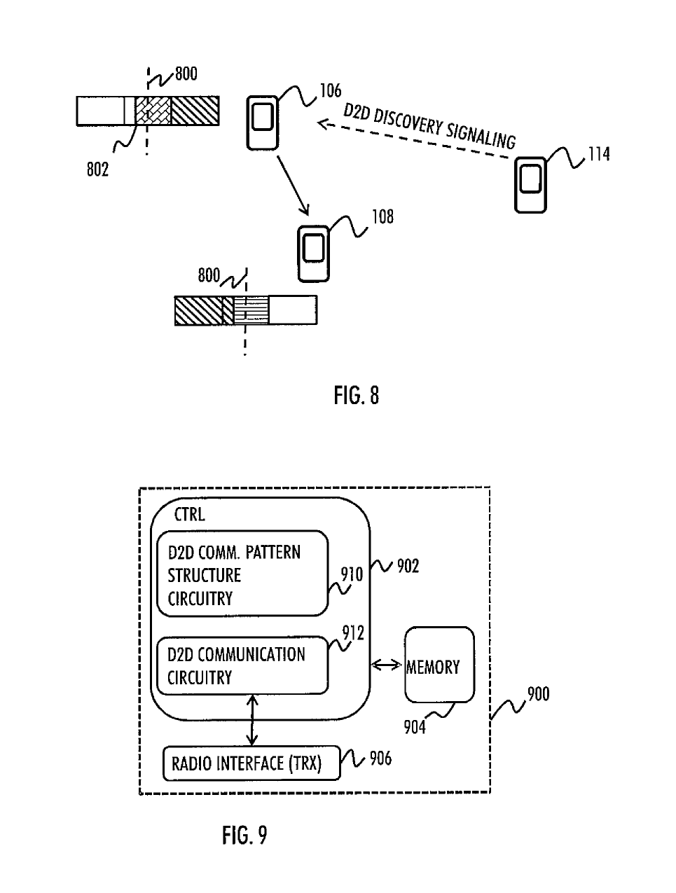

It should be also noted that during the GP period, the device may receive data from the transmitter, as shown in the Figures. When TA is applied, the device may also transmit data during the GP period as FIG. 6 showed. However, during the SP period, no transmission or reception for the current device is ongoing. Therefore, this SP duration may potentially be used for other purpose. Let us assume, as shown in FIG. 8, that the first UT 106 has transmitted data to the second UT 108. The present point 800 of time is already at the last Tx subframe during the SP 802. Thus, the first UT 106 has ended its transmission but the receiver is still receiving the data on a guard period so as to compensate the propagation delay. Instead of being idle, the UT 106 may perform some other functionality, which may not relate to the present D2D communication pair (UT 106-UT 108). In an embodiment as shown in FIG. 8, it is proposed that the first user terminal 106 may perform discovery signal detection from a third user terminal 114 during the silent period 802. Alternatively or in addition to, the first user terminal may connect to the eNB, for example.

An embodiment, as shown in FIG. 9, provides an apparatus 900 comprising at least one processor 902 and at least one memory 904 including a computer program code, wherein the at least one memory 904 and the computer program code are configured, with the at least one processor 902, to cause the apparatus 900 to carry out any one of the above-described processes related to determining the structure (configuration) of at least one communication interval of the D2D communication pattern. It should be noted that FIG. 9 shows only the elements and functional entities required for understanding the apparatus 900. Other components have been omitted for reasons of simplicity. The implementation of the elements and functional entities may vary from that shown in FIG. 9. The connections shown in FIG. 9 are logical connections, and the actual physical connections may be different. The connections can be direct or indirect and there can merely be a functional relationship between components. It is apparent to a person skilled in the art that the apparatus may also comprise other functions and structures.

The apparatus 900 may comprise the terminal device of a cellular communication system, e.g. a computer (PC), a laptop, a tabloid computer, a cellular phone, a communicator, a smart phone, a palm computer, or any other communication apparatus. In another embodiment, the apparatus is comprised in such a terminal device, e.g. the apparatus may comprise a circuitry, e.g. a chip, a processor, a micro controller, or a combination of such circuitries in the terminal device and cause the terminal device to carry out the above-described functionalities. Further, the apparatus 900 may be or comprise a module (to be attached to the UE) providing connectivity, such as a plug-in unit, an “USB dongle”, or any other kind of unit. The unit may be installed either inside the UE or attached to the UE with a connector or even wirelessly.

As said, the apparatus 900 may comprise the at least one processor 902. The at least one processor 902 may be implemented with a separate digital signal processor provided with suitable software embedded on a computer readable medium, or with a separate logic circuit, such as an application specific integrated circuit (ASIC). The at least one processor 902 may further comprise an interface, such as computer port, for providing communication capabilities.

The at least one processor 902 may also comprise a D2D communication pattern structure circuitry 910 for determining the structure of at least one communication interval, such as a subframe, in at least one D2D communication pattern. The determination may take into account the application of timing advance in the paired device(s), the propagation delay(s) to/from the paired device(s), the broadcasted switching time from Tx to Rx or vice versa in the D2D communication, etc. The at least one processor 902 may further comprise a D2D communication circuitry 912 for performing communication directly with another user terminal.

The apparatus 900 may further comprise radio interface components 906 providing the apparatus with radio communication capabilities with the radio access network. The radio interface components 906 may comprise standard well-known components such as amplifier, filter, frequency-converter, (de)modulator, and encoder/decoder circuitries and one or more antennas. The interface 906 may be used for transmission and reception of D2D data, reception and transmission of D2D related control signalling from the eNB, TA information, etc.

As said, the apparatus 900 may comprise a memory 904 connected to the processor 904. However, memory may also be integrated to the processor 902 and, thus, no memory 904 may be required. The memory 904 may be for storing data related to the application of TAs in the paired device(s), the configuration of D2D communication pattern obtained from the network, for example, or derived by the device itself, etc.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processors), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configure to carry out embodiments of any of the FIGS. 1 to 9. In an embodiment, the at least one processor 902, the memory 904, and the computer program code form an embodiment of processing means for carrying out the embodiments of the invention. According to an embodiment, the apparatus comprises means for performing the tasks of FIGS. 1 to 9.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
determining, at a first user terminal capable of performing a direct device-to-device (D2D) communication with a second user terminal, whether to advance transmission in the D2D communication or not;
obtaining information indicating whether the second user terminal is advancing its transmission in the D2D communication or not; and
determining a structure for at least one communication interval in a D2D communication pattern at least partly based on the application of transmission timing advances at the first and second user terminals, wherein the D2D communication pattern comprises communication intervals allocated for communication for the first user terminal with respect to the second user terminal.

2. The method of claim 1, further comprising:
determining the presence and the length of at least one of the following; a guard period and a silent period in the at least one communication interval when determining the structure, wherein the silent period is applicable once after transmission and before reception of information in the D2D communication, and the guard period is applicable once after reception and before transmission of information m the D2D communication.

3. The method of claim 1, further comprising:
determining whether or not to apply a silent period in the at least one communication interval based on whether the first user terminal does or does not apply the transmission timing advance, wherein the silent period is applied once after transmission and before reception of information in the D2D communication.

4. The method of claim 2, wherein at least one of the silent period and the guard period is comprised in the last communication interval allocated for transmission in the D2D communication pattern with respect to a current D2D communication pair.

5. The method of claim 4, further comprising:
causing the first user terminal to perform discovery signal detection from a third user terminal during the silent period.

6. (canceled)

7. The method of claim 1 further comprising:
determining to apply a guard period in the at least one communication interval when the second user terminal does not apply the transmission timing advance, wherein the guard period is applied once after reception and before transmission of information in the D2D communication.

8. (canceled)

9. The method of claim 1 further comprising:
determining not to apply a guard period in the at least one communication interval when the second user terminal applies the transmission timing advance.

10. The method of claim 1 wherein, when the D2D communication pattern comprises a silent period and/or a guard period, the length of the silent period or the guard period corresponds to at least two times the sum of a propagation delay between the first and the second user terminal and a duration of switching from transmission to reception or vice versa.

11. (canceled)

12. The method of claim 1, further comprising:
causing transmission of information to the second user terminal, wherein the information indicates whether the first user terminal is advancing its transmission in the D2D communication.

13. (canceled)

14. The method of claim 1 further comprising:
determining the structure for at least one communication interval in a plurality D2D communication patterns corresponding to a plurality of D2D communication pairs when there is a plurality of second user terminals, wherein the determination is based at least partly on the application of the transmission timing advances in each of the plurality of D2D communication pairs, and the communication interval is a subframe.

15. An apparatus, comprising:
at least one processor and at least one memory including a computer program code, wherein the at least one memory and the computer program code are configured to, with the at least one processor, cause the apparatus at least to:
determine whether or not to advance transmission in a direct device-to-device (D2D) communication of a first user terminal capable of performing the D2D communication with a second user terminal;
obtain information indicating whether the second user terminal is advancing its transmission in the D2D communication or not; and
determine a structure for at least one communication interval in a D2D communication pattern at least partly based on the application of transmission timing advances at the first and second user terminals, wherein the D2D communication pattern comprises communication intervals allocated for communication for the first user terminal with respect to the second user terminal.

16. The apparatus of claim 15, wherein the apparatus is further caused to:
determine the presence and the length of at least one of the following; a guard period and a silent period in the at least one communication interval when determining the structure, wherein the silent period is applicable once after transmission and before reception of information in the D2D communication, and the guard period is applicable once after reception and before transmission of information in the D2D communication.

17. The apparatus of claim 15, wherein the apparatus is further caused to:
determine whether to apply a silent period in the at least one communication interval based on whether the first user terminal does or does not apply the transmission, timing advance,
wherein the silent period is applied once alter transmission and before reception of information in the D2D communication.

18. The apparatus of claim 16, wherein one of the silent period and the guard period is comprised in the last communication interval allocated for transmission in the D2D communication pattern with respect to a current D2D communication pair.

19. The apparatus of claim 17, wherein the apparatus is further caused to:
cause the first user terminal to perform discovery signal detection from a third user terminal during the silent period.

20. (canceled)

21. The apparatus of claim 1, wherein the apparatus is further caused to:
determine whether or not to apply a guard period in the at least one communication interval based on whether the second user terminal does or does not apply the transmission timing advance,
wherein the guard period is applied once after reception and before transmission of information in the D2D communication.

22-23. (canceled)

24. The apparatus of claim 15, wherein, when the D2D communication pattern comprises a silent period and/or a guard period, the length of the silent period or the guard period corresponds to at least two times the sum of a propagation delay between the first and the second user terminal and a duration of switching from transmission to reception or vice versa.

25. (canceled)

26. The apparatus of claim 15, wherein the apparatus is further caused to:
cause transmission of information to the second user terminal, wherein the information indicates whether the first user terminal is advancing its transmission in the D2D communication.

27. (canceled)

28. The apparatus of claim 15, wherein the apparatus is further caused to:
determine the structure for at least one communication Interval in a plurality D2D communication patterns corresponding to a plurality of D2D communication pairs when there is a plurality of second user terminals, wherein the determination is based at least partly on the application of the transmission timing advances in each of the plurality of D2D communication pairs and the communication interval is a subframe.

29. (canceled)

30. A computer readable memory tangibly storing a computer program that is readable by a computer and comprising program instructions which, when loaded into a first user terminal capable of performing a direct device to device (D2D) communication with a second user terminal, causes the first user terminal to:
determine whether or not to advance transmission by the first user terminal in the D2D communication;
obtain information indicating whether or not the second user terminal is advancing its transmission in the D2D communication; and
determine a structure for at least one communication interval in a D2D communication pattern based at least partly on the application of transmission timing advances at the first and second user terminals, wherein the D2D communication pattern comprises communication intervals allocated for communication for the first user terminal with respect to the second user terminal.
